(19) United States
(12) Patent Application Publication
(10) Pub. No.: US 2010/0175065 A1
(43) Pub. Date: Jul. 8, 2010

(54) WORKFLOW MANAGEMENT DEVICE, WORKFLOW MANAGEMENT METHOD, AND PROGRAM

(75) Inventor: Momoe Uchida, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/640,720

(22) Filed: Dec. 17, 2009

(30) Foreign Application Priority Data
Jan. 5, 2009 (JP) 2009-000389

(51) Int. Cl. G06F 9/46

(52) U.S. Cl. 718/102

(57) ABSTRACT

This invention is directed to a workflow execution method capable of allocating a necessary license in accordance with the workflow contents and the license states of all task processing devices capable of executing a task, and preferentially utilizing the license in task execution in a cooperative task processing system capable of executing a plurality of tasks for document data as a workflow by a plurality of task processing devices.

### BACKGROUND OF THE INVENTION

1. Field of the Invention

The present invention relates to a workflow management device and workflow management method for, for example, executing and managing a workflow formed from, for instance, tasks.

2. Description of the Related Art

There has conventionally been proposed a task processing device which can set a job flow by combining a set of processes in series or in parallel, such as Fax transmission, scanning, and printing for document data (see Japanese Patent Laid-Open No. 2004-287859). The task processing device causes devices connected to a network to process a series of tasks cooperatively. In Japanese Patent Laid-Open No. 2004-287859, task processing devices capable of processing tasks in a job flow sequentially process target tasks in cooperation with each other. A plurality of tasks can be handled as one job flow, reducing the burden on the user when processing document data.

There is also proposed a license management system in which, if necessary, a license is issued from a license management server to a terminal device and after using the license, automatically returned to the license management server (see Japanese Patent Laid-Open No. 2005-055957).

In addition, a job flow execution system is proposed, which sets a necessary license before execution of a job flow, based on a defined job flow and the license state of a task processing device for executing a job (Japanese Patent Application No. 2006-344722).

### SUMMARY OF THE INVENTION

Japanese Patent Laid-Open No. 2004-287859 does not particularly consider a license necessary for task processing. This task processing device may fail to normally execute a job flow when, for example, the license form is changed regardless of the job flow definition. As a solution to this problem in Japanese Patent Laid-Open No. 2004-287859, Japanese Patent Application No. 2006-344722 proposes a system to which the license management system in Japanese Patent Laid-Open No. 2005-055957 is applied. In this system, a license necessary to execute a job flow is set in a task processing device and then the job flow is executed.

However, the solution proposed in Japanese Patent Application No. 2006-344722 is based on the assumption that task processing devices for executing a job flow are narrowed down to one before execution of the job flow. If task processing devices for executing each task in a job flow cannot be narrowed to one, a license necessary for processing cannot be prepared in advance. In some cases, a job flow which has started is suspended and what is worse, may be stopped.

The present invention has been made in consideration of the above situation, and provides to solve the above problems. More specifically, the present invention provides a workflow management device, workflow management method, and program for allocating a license in accordance with the license state of each task processing device capable of executing a task, and the workflow contents, and reliably executing a workflow which has started.

According to one aspect of the present invention, there is provided a workflow management device which executes, by using a task processing device, a series of processes for document data as a workflow formed from a combination of tasks, the workflow management device comprising: a determination unit which determines, sequentially for the tasks in the workflow, whether to execute a target task by the task processing device; a license allocation unit which, when the determination unit determines to execute the target task by the task processing device, allocates a license necessary to execute the target task by the task processing device; a license determination unit which determines whether a license is necessary when executing the target task; an installation unit which, when a license is determined to be necessary, installs the license allocated by the license allocation unit in a target task processing device for processing the target task; and a license allocation release unit which, when a license is determined to be unnecessary, releases the license allocated by the license allocation unit.

The following effects can be obtained via the present invention:

(1) a workflow can be efficiently executed without awareness of the form of a license set in a task processing device, and

(2) a workflow whose processing has started can be reliably executed and completed.

Further features of the present invention will become apparent from the following description of exemplary embodiments (with reference to the attached drawings).

### BRIEF DESCRIPTION OF THE DRAWINGS

FIG. 1 is a view of the configuration of a cooperative task processing system according to an embodiment;

FIG. 2 is a block diagram of a module configuration in the embodiment;

FIG. 3 is a view of workflow definition information in the embodiment;

FIG. 4 is a view of the configuration of a cooperative task processing system in Embodiment 1 of the present invention;

FIG. 5 is a view of a workflow in Embodiment 1 of the present invention;

FIG. 6 is a view of the operation sequence of task processing in Embodiment 1 of the present invention;

FIG. 7 is a flowchart of the overall sequence of task processing in Embodiment 1 of the present invention;

FIG. 8 is a flowchart of the sequence of license allocation processing in Embodiment 1 of the present invention;

FIG. 9 is a flowchart of the sequence of task execution processing in Embodiment 1 of the present invention;

FIG. 10 is a flowchart of the sequence of license allocation processing in Embodiment 2 of the present invention;

FIG. 11 is a view of the arrangement of task processing devices in Embodiment 3 of the present invention;

FIG. 12 is a view of workflows in Embodiment 3 of the present invention;

FIG. 13 is a flowchart of the sequence of license allocation processing (allocation processing based on the number of task processing devices) in Embodiment 3 of the present invention;

FIG. 14 is a view of an integrated license allocation example (allocation processing based on the number of task processing devices) in Embodiment 3 of the present invention;

FIG. 15 is a flowchart of the sequence of license allocation processing (allocation processing based on user information) in Embodiment 3 of the present invention;

FIG. 16 is a view of an integrated license allocation example (allocation processing based on user information) in Embodiment 3 of the present invention;

FIG. 17 is a flowchart of the sequence of task execution processing in Embodiment 3 of the present invention;

FIG. 18 is a flowchart of integrated license allocation release processing in Embodiment 3 of the present invention;

FIG. 19 is a flowchart of the sequence of license allocation processing in Embodiment 4 of the present invention;

FIG. 20 is a flowchart of the sequence of task execution processing in Embodiment 4 of the present invention;

FIG. 21 is a view exemplifying a license allocation timing in Embodiment 4 of the present invention; and

FIG. 22 is a flowchart of the sequence of license allocation processing in Embodiment 5 of the present invention.

### DESCRIPTION OF THE EMBODIMENTS

Embodiments of the present invention will be described below. Before a description of the embodiments of the present invention, a system configuration and application configuration to which the present invention is applicable will be explained.

<System Configuration>

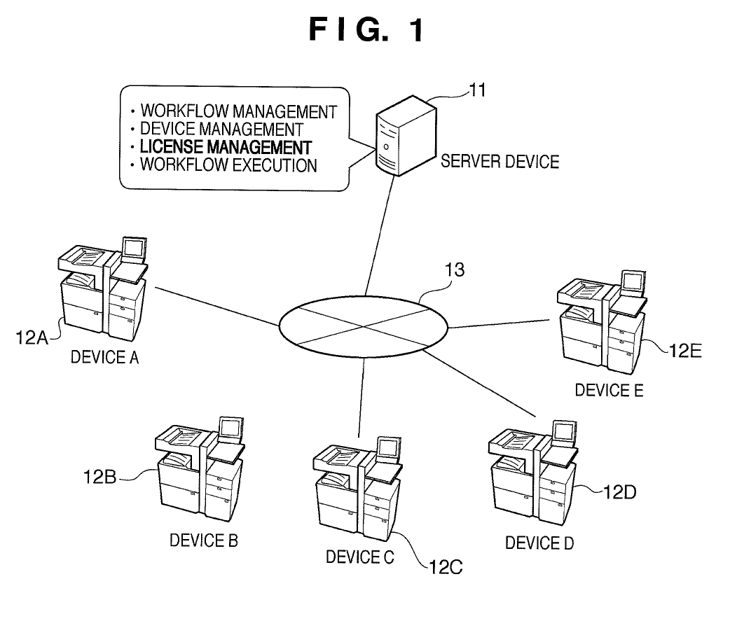

FIG. 1 shows the overall configuration of a cooperative task processing system according to an embodiment of the present invention. The cooperative task processing system includes devices capable of cooperatively executing a variety of tasks. A task in the embodiment indicates processing executable for document data.

For example, tasks in a print processing device are processes for document data, such as copying, scanning, Fax transmission, save in a storage medium (e.g., hard disk) in the print processing device, and mail transmission of document data.

Tasks are not particularly limited to the input/output processes and save process as long as they are processes for document data. In addition, manipulation processes accompanied by a manual operation, such as editing and authorization of document data, may be handled as tasks. Tasks may further include other processes.

In the cooperative task processing system, a print processing device which provides tasks, and a plurality of applications and a plurality of devices capable of providing various kinds of tasks can cooperate with each other. In the present invention, the print processing device and application capable of executing tasks are defined as task processing devices.

The application includes an application program such as a document processing program which runs in a general-purpose computer and digital multifunctional peripheral. The application that forms the cooperative task processing system refers to a device such as a computer which executes the application program. In the following description, the device will be simply referred to as an application. In addition to the application, the task processing devices include, for example, a single-function scanner and printer, and a digital multifunctional peripheral having a copy, scan, Fax transmission, and print processing functions.

The cooperative task processing system comprises a server device 11 functioning as a workflow management device, and task processing devices 12A to 12E, which are connected to a network 13. By using a communication protocol such as TCP/IP or SNMP, data can be communicated between the task processing devices and between the task processing devices and the server device 11. The number of devices of each type is not limited and the system configuration is changeable. The system can include a plurality of networks. The following description assumes a cooperative task processing system in which one server device and five task processing devices are connected to a network.

The server device 11 manages task processing devices such as a print processing device and application, and a plurality of workflows. In workflow management, the server device 11 has a task extraction function of extracting a task which forms a workflow. The server device 11 also manages information (application information) of an application installed in a task processing device under management, and the form of a license (license form). The server device 11 has a workflow execution control function.

In the embodiment, to execute a task, a license capable of executing the target task needs to be installed in a task processing device. As the license form, there are two types: a floating license issued by the server device every time a task processing device requests a license, and a fixed license installed in advance in a task processing device.

As the floating license form, the server which manages the cooperative task system holds a predetermined number of licenses, and gives a license to a license-requesting task processing device.

A license for a task processing device is licensing information itself which licenses the use of a task processing device or application. A license is given by transmitting it to a task processing device. A license is canceled by, for example, recovering it from a task processing device.

A license in the floating license form will be simply described as a license, unless otherwise specified.

<Module Configuration View>

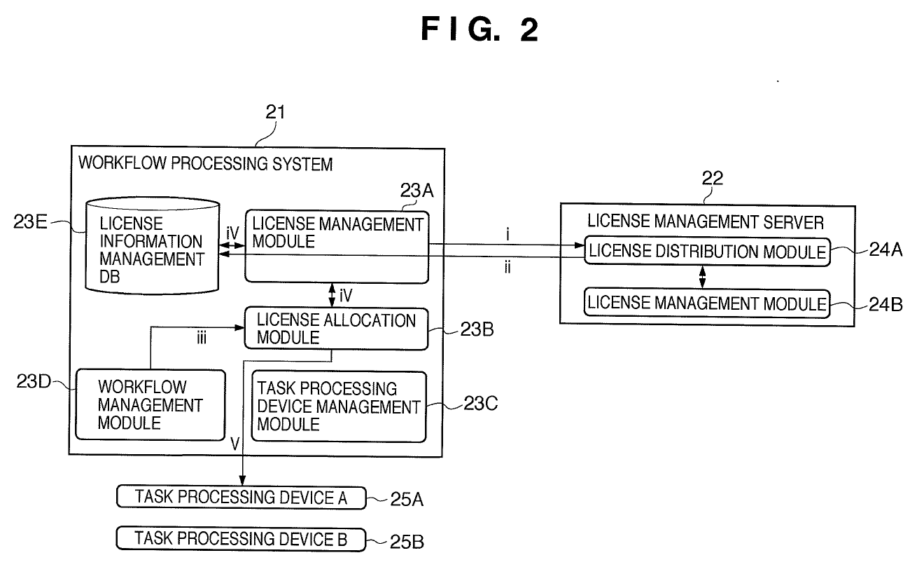

FIG. 2 shows the module configuration of the cooperative task processing system. A workflow processing system 21 is a program in the server device 11 which executes license management, workflow management, and task processing device management. A license management server 22 manages licenses and includes a license distribution module 24A and license management module 24B. The license management server 22 issues a license in response to a request from the workflow processing system 21.

As for a fixed license, the license management server 22 directly issues a license to a task processing device. The license management server 22 may reside in the server device 11 or the server device of another housing.

When the license management server 22 exists in another housing, the workflow processing system 21 and license management server 22 are connected via a network to be able to communicate data.

The workflow processing system 21 includes a license management module 23A, license allocation module 23B, task processing device management module 23C, workflow management module 23D, and license information management database (license information management DB) 23E.

The license management module 23A performs license management in the workflow processing system 21.

The license management is a function of managing the number of issuable licenses and that of issued licenses, and performing license issue control and recovery processing in response to a license issue request. In the cooperative task processing system, the license management module 23A issues a license in accordance with a request from the license allocation module 23B.

The license allocation module 23B analyzes a workflow based on workflow information obtained from the workflow management module 23D. Also, the license allocation module 23B allocates, issues, and releases a license based on the license state of a task processing device.

The task processing device management module 23C manages a task processing device which can be requested by the server device 11 to process a task.

The workflow management module 23D manages arbitrary workflow definition information and the execution state of a workflow.

The license information management DB 23E manages a license issued by the license management server 22. The license information management DB 23E provides and manages a license in response to a request from the license management module 23A.

A task processing device A 25A and task processing device B 25B can process tasks of a workflow managed by the workflow management module 23D, and are connected to the workflow processing system 21 via a network. Note that the task processing device A 25A and task processing device B 25B correspond to the task processing devices 12A to 12E shown in FIG. 1.

<Outline of Processing Sequence in a Cooperative Task Processing System>

The general sequence of processing in the cooperative task processing system will be exemplified with reference to FIG. 2. In the cooperative task processing system, the license management module 23A requests the license management server 22 to issue a license in order to utilize a floating license (1).

Upon receiving the license issue request from the workflow processing system 21, the license distribution module 24A in the license management server 22 sends an inquiry to the license management module 24B.

Upon receiving the inquiry, the license management module 24B issues a managed license. The license distribution module 24A then distributes the license (2). The license information management DB 23E internally manages the issued license.

These procedures are executed upon, for example, updating the system configuration or license. The analysis of the workflow generally starts after these processes are performed.

After issuing the license and storing it in the license information management DB 23E, a workflow managed by the workflow management module 23D changes to the execution state at an arbitrary timing. After the workflow changes to the execution state, the license allocation module 23B receives the target workflow from the workflow management module and analyzes a series of tasks (3). After that, the license allocation module 23B allocates, from the license information management DB 23E via the license management module, a license necessary to execute each task (4).

If the task processing device 25A to which task processing is assigned requires a license in task execution, the license allocation module 23B issues the allocated license to the task processing device (5). After executing the task, the task processing device 25A returns the issued license to the license allocation module 23B (not shown). Return of the license refers to return of an assigned license from the task processing device to the server according to generally executed procedures.

<Workflow Definition Information>

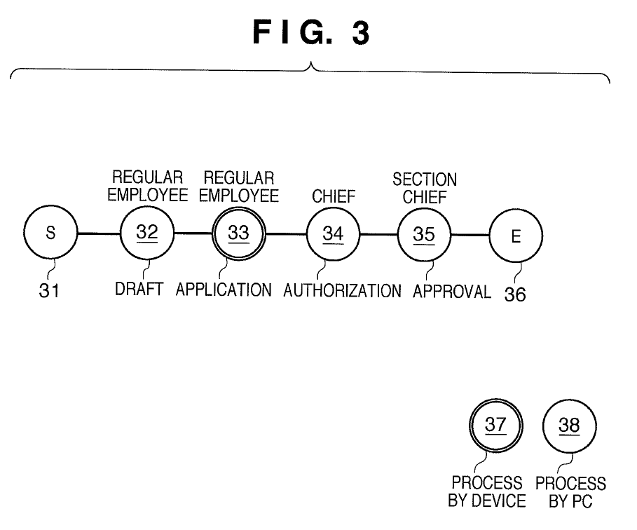

FIG. 3 exemplifies a workflow according to the embodiment of the present invention. The workflow in the embodiment is formed from tasks 32 to 35. These tasks can be classified into a task 37 to be processed by a task processing device and a task 38 to be processed by a client computer (to be referred to as a PC).

In FIG. 3, the task 32 (draft), task 34 (authorization), and task 35 (approval) indicated by solid lines are tasks to be processed by the PC, and the task 33 (application) indicated by a double line is a task to be processed by the task processing device. A role for identifying the execution user of each task is assigned to a task. A regular employee role is assigned to the task 32 (draft) and task 33 (application), a chief role is assigned to the task 34 (authorization), and a section chief role is assigned to the task 35 (approval). The role is also called a task execution user. Every time a task ends, the cooperative task processing system assigns a user role to a task to be processed next.

In this way, the workflow definition information contains task definition information which defines a task in the workflow. The processing order of pieces of task definition information is defined by, e.g., the arrangement order in the workflow definition information.

The task definition information defines the identifier of a task, the type of processing to be executed by the task (function for performing the processing), a role representing a user in charge of the task, document data to be processed, and the like. By referring to the contents of the task definition information, a task processing device and role capable of executing a task can be identified.

An input task such as a scan or OCR task can be sometimes executed asynchronously from another task. For such a task, the order need not be defined, and a trigger to execute the task is input not from the workflow processing system but from a task processing device.

The above-described system configuration and data definition are commonly applied throughout embodiments to be described below.

### Embodiment 1

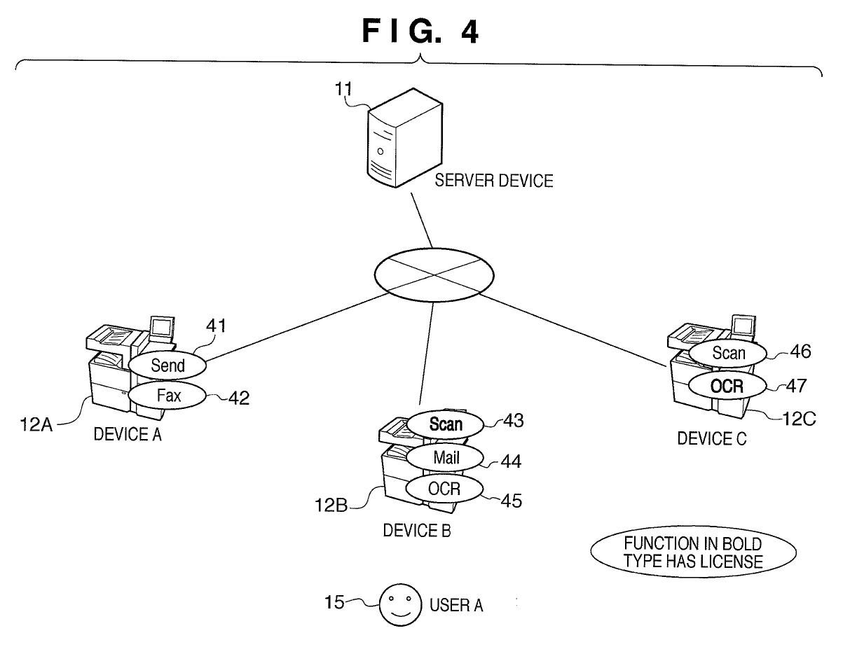

Embodiment 1 in the present invention will now be described. FIG. 4 shows a system configuration in Embodiment 1. Embodiment 1 adopts three task processing devices, i.e., a device A 12A, device B 12B, and device C 12C. Embodiment 1 assumes that a user A 15 having a regular employee role exists as a user who manipulates the task of a workflow.

In FIG. 4, reference numerals 41 to 47 denote functions in the respective task processing devices and the install states of fixed licenses. A function described in bold type has a fixed license installed.

The device A 12A has the functions of the Send 41 and Fax 42, and their fixed licenses are not installed. The device B 12B has the functions of the Scan 43, Mail 44, and OCR 45, and the fixed license of only the function of the Scan 43 is installed. The device C 12C has the functions of the Scan 46 and OCR 47, and the fixed license of the function of the OCR 47 is installed.

<Example of Task Processing Sequence>

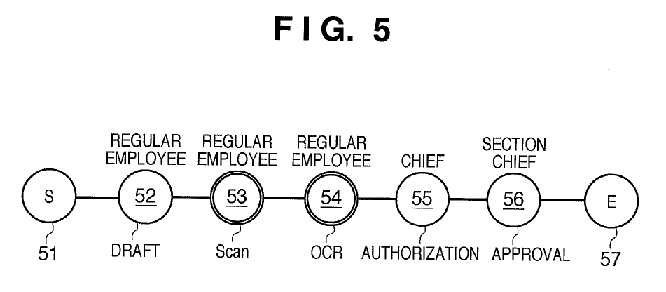

FIG. 5 shows a workflow in Embodiment 1. This workflow is made up of a task 52 (draft), task 53 (Scan), task 54 (OCR), task 55 (authorization), and task 56 (approval). The task 52 (draft), task 55 (authorization), and task 56 (approval) are processed by the PC. The task 53 (Scan) and task 54 (OCR) are processed by the task processing device. A user role is assigned to each task. In FIG. 5, the role is described at the upper right of a task. The workflow in FIG. 5 is an example in which document data drafted by the task 52, document data scanned and input by the task 53, and a document OCRed and input by the task 54 are authorized by the task 55 and approved by the task 56.

<Processing Sequence in Embodiment 1>

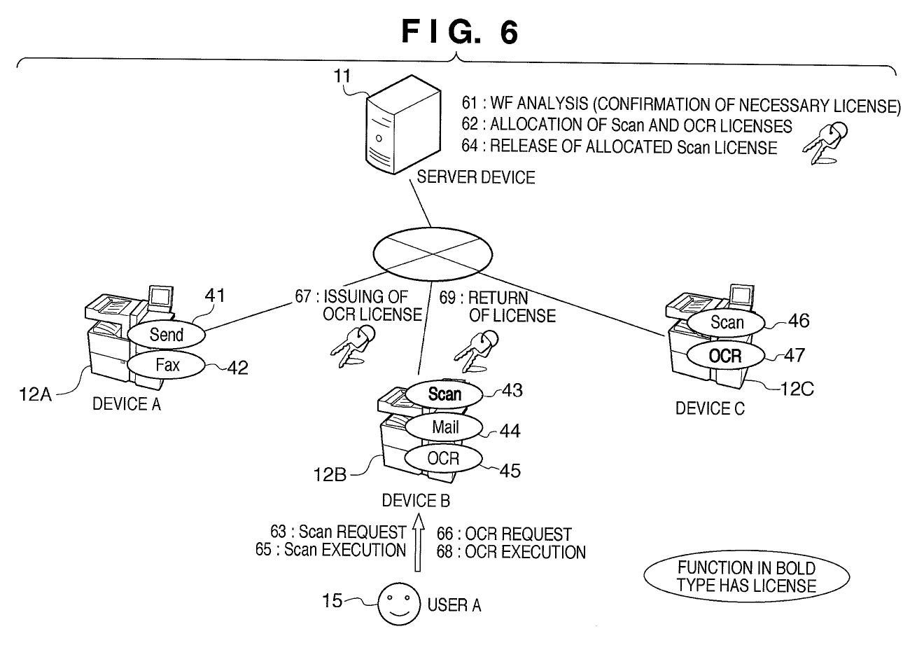

FIG. 6 shows the sequence of an overall operation in Embodiment 1. When the workflow shown in FIG. 5 starts in a server device 11, a workflow management module 23D analyzes the workflow contents and determines licenses necessary for a task processing device (61). In Embodiment 1, it is determined that a Scan license and OCR license are required to process the task 53 (Scan) and task 54 (OCR) in the task processing device.

The server device 11 identifies the install states of licenses in the available task processing devices 12A, 12B, and 12C and allocates licenses necessary to processes tasks in the workflow (62). First, the server device 11 searches for a task processing device having a function capable of processing a task. Then, the server device 11 confirms the install state of the fixed license of the function of the detected task processing device. In addition, the server device 11 allocates a license necessary for the task processing.

In Embodiment 1, task processing devices capable of processing the task 53 (Scan) are the device B 12B and device C 12C, and task processing devices capable of processing the task 54 (OCR) are the device B 12B and device C 12C. In the device B 12B, the fixed license of the Scan function is installed but that of the OCR function is not installed.

To the contrary, in the device C 12C, the fixed license of the Scan function is not installed but that of the OCR function is installed. The license is allocated at the same time as the confirmation of the install state. In this case, the server device 11 allocates one license for the Scan function and one license for the OCR function so that either task processing device can process the tasks.

After license allocation, the server device 11 requests task processing of each task processing device in order to sequentially process the tasks in accordance with the workflow contents.

After the task processing request, the server device confirms the fixed license state of the task processing device which is to process the tasks. When the fixed license of the target function to be executed has been installed, the server device 11 executes allocation release processing for the allocated license.

If no fixed license has been installed, the server device 11 issues the allocated license to the task processing device. Upon completion of the processing, the task processing device returns the issued license to the server device 11.

As for an asynchronous task, the server device 11 need not always request task processing of a task processing device, as described above. In this case, when a task processing device in the workflow processing system is notified during execution of the workflow to execute such an asynchronous task, the execution of the task is regarded to form the workflow in progress. According to this method, it is difficult to identify a task when one workflow includes a plurality of asynchronous tasks. Hence, for example, the execution order is determined in advance to identify a task based on the execution order.

A request to execute each task may be issued from the workflow processing system to the task processing device regardless of whether the task is synchronous or asynchronous. In this case, the correspondence between a task in process and the workflow is clarified.

As for the tasks 53 and 54 to be executed by the task processing device upon completion of processing the task 52, Embodiment 1 assumes that the user A 15 instructs the task processing device B 12B to execute the task 53 (Scan) and task 54 (OCR) in the order named.

The scan task and OCR task in this case are input tasks executable asynchronously from other tasks. In Embodiment 1, therefore, the server device 11 does not instruct the task processing device to execute the tasks.

As for a task to be processed by an application, like the task 52, the workflow processing system 21 instructs, on the processing, a computer capable of executing a designated function. Upon completion of the processing, the workflow processing system 21 receives processed data together with a notification that the designated processing is complete, and transfers the data to the next task.

As for a task executable asynchronously from other tasks, like “draft”, the PC may activate the task, similar to “scan”.

In Embodiment 1, the user A requests the device B to execute Scan processing which is a task extracted from the workflow (63). In this state, the license has been allocated. The device B serving as the task processing device notifies the server device 11 of the task execution request. Upon receiving the notification that the device B has been requested of Scan processing, the server device 11 determines that the notification is a processing request notification associated with a scan task contained in the workflow in progress. The server device 11 determines the fixed license state of the device B.

In this example, the fixed license of the function to be executed has been installed. Thus, the server device 11 releases the license allocated for the Scan function (64).

Since the device B has the license, it executes the task 53 (Scan) in response to the Scan processing request (65). The device B transmits document data scanned by the scan task 53 to the server device 11.

Similar to the task 53 (Scan), the user A 15 requests the device B to execute the task 54 (OCR) which is a task extracted from the workflow (66). The device B notifies the server device 11 of a message to this effect. In Embodiment 1, the fixed license of the OCR function is not installed in the device B. Upon receiving the notification that the device B has been requested to execute the task 54, the server device 11 determines that a license is necessary, and issues the allocated OCR license to the device B (67).

By using the issued OCR license, the device B executes the task 54 (OCR) (68). After executing the task, the device B returns the OCR license used to the server device 11 (69).

<Overall Processing Sequence in Embodiment 1>

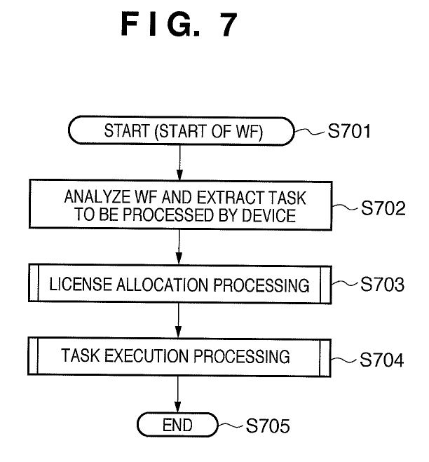

FIG. 7 shows an overall processing sequence in Embodiment 1. The server device 11 which manages a workflow executes the sequence in FIG. 7. The processing exemplified in FIG. 6 starts at an arbitrary timing after the workflow in the server device 11 starts.

After the start of processing, the server device 11 analyzes the workflow contents to extract tasks to be processed by a task processing device (S702). The server device 11 allocates a license necessary to process each extracted task (S703). The task processing device executes the tasks sequentially in accordance with the workflow contents.

<License Allocation Processing Sequence>

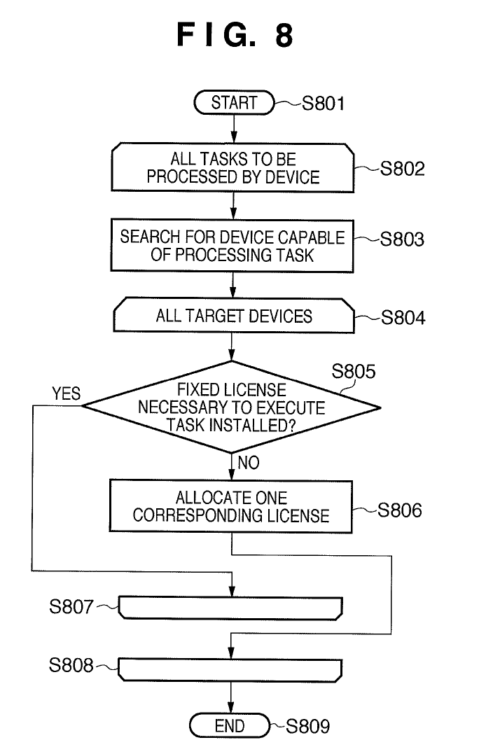

FIG. 8 shows the sequence of license allocation processing for a task in Embodiment 1. This processing is done for all tasks extracted from a target workflow. First, task processing devices capable of processing a target task are searched for (S803). This processing is executed for all task processing devices extracted in S803.

It is determined whether a fixed license for executing the task has been installed in a target task processing device (S805). If the fixed license has been installed, the determination processing is done for the next task processing device (S807). If no fixed license has been installed, one license for executing the task is allocated (S806). The license determination processing is repeated for the next task. After executing the processing for all tasks, the license allocation processing ends.

Embodiment 1 assumes a situation in which a task processing device for executing tasks extracted from a workflow cannot be identified till execution of the tasks. In this situation, no fixed license may have been installed in the task processing device assigned in actual task processing. When, therefore, even one task processing device having no fixed license exists in task processing devices capable of executing the task, a license for executing the task is allocated.

<Task Execution Processing Sequence>

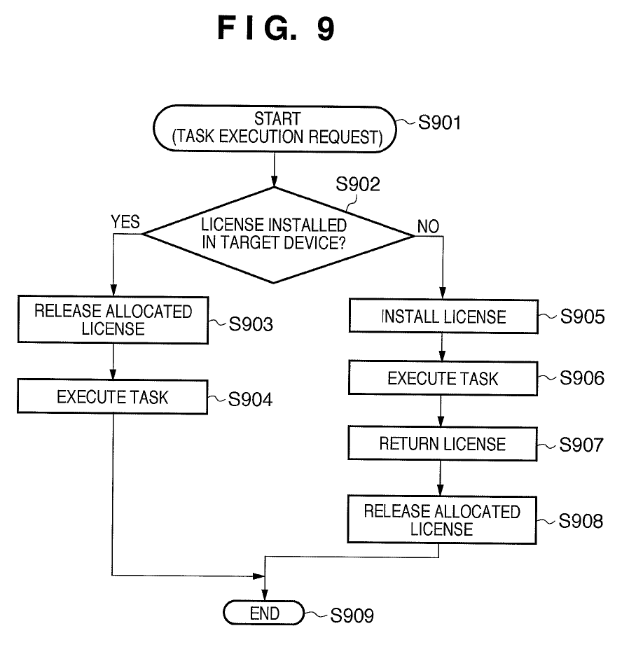

FIG. 9 shows a processing sequence when executing a task in Embodiment 1. The process starts when the user requests an arbitrary task processing device to execute a target task. It is determined whether a fixed license capable of executing the task has been installed in the task processing device designated by the user (S902).

If the fixed license has been installed, a license allocated in the server device to execute the task is released (S903). Thereafter, the task is executed (S904). If no fixed license has been installed, the license allocated in the server device to execute the task is installed in the task processing device (S905). The task is then executed (S906).

After executing the task, the task processing device returns the license used to the server device (S907). The server releases the allocated license (S908).

As described above, according to Embodiment 1, a license is allocated in consideration of the license state of each task processing device capable of processing a task. A license necessary for processing can be efficiently allocated to reliably execute and complete a target workflow.

### Embodiment 2

Embodiment 2 in the present invention will now be described. Embodiment 2 will explain license allocation processing different from that in Embodiment 1. Embodiment 1 has exemplified a case in which a license to be allocated is decided based on the workflow contents and the install state of a fixed license in an available task processing device. Embodiment 2 will exemplify a case in which a license to be allocated is decided from the workflow contents.

<License Decision Sequence Based on Workflow>

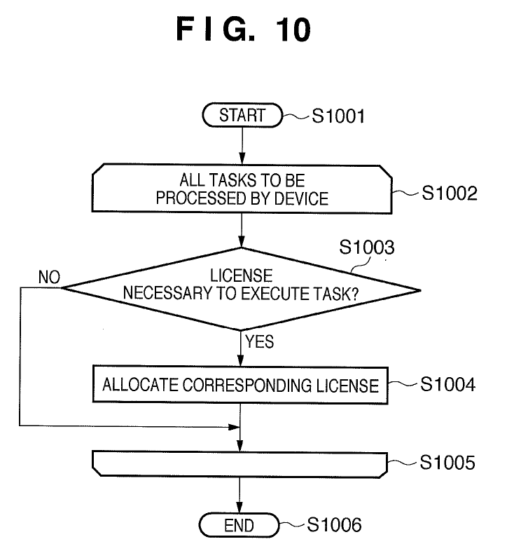

FIG. 10 shows a license allocation processing sequence executed by a server 11 in Embodiment 2. This processing is done for all tasks extracted from a target workflow (S1002). It is determined whether a license is necessary to execute a target task (S1003).

If the task requires a license, a license necessary to execute the task is allocated (S1004). If the task does not require a license, no license is allocated. After performing the processing for all tasks, the license allocation processing ends. As described above, according to Embodiment 2, license allocation processing can be executed to only determine whether a license is necessary to execute a task. This can reduce the load of the license allocation processing, executing it quickly. The determination in S1003 is desirably made in consideration of the possibility that a license is necessary.

### Embodiment 3

Embodiment 3 in the present invention will now be described. Embodiment 3 will explain license allocation processing different from those in Embodiments 1 and 2. Embodiments 1 and 2 have exemplified a case in which licenses necessary to process respective tasks extracted from a workflow are allocated one by one. In actual operation, however, many different workflows are likely to be executed simultaneously. Along with this, many licenses need to be allocated.

To cope with this, Embodiment 3 will exemplify a case in which when the same license is necessary to process even tasks in different workflows, licenses are integrated to allocate an integrated license. Allocating a license by “integration” indicates allocating only a minimum number of necessary licenses without repetitively holding licenses necessary for different tasks belonging to a plurality of workflows.

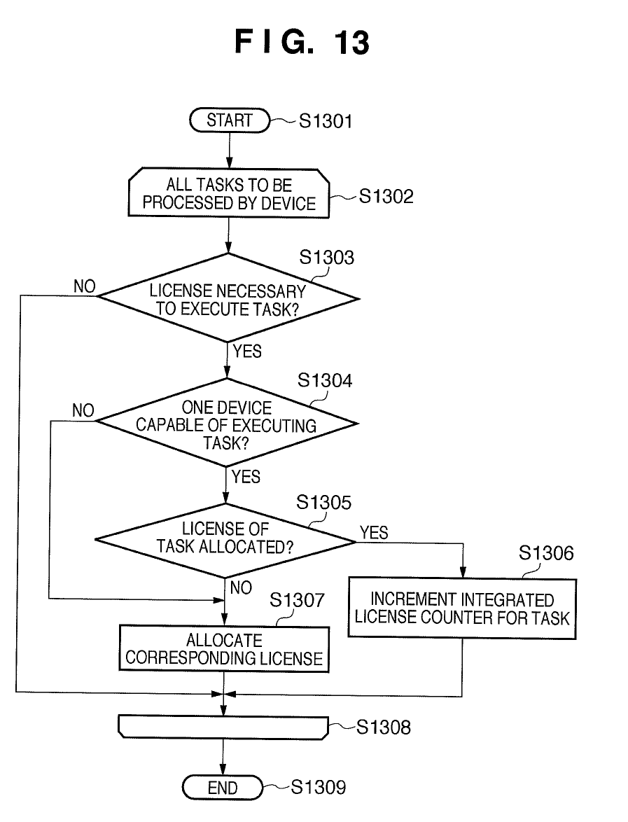

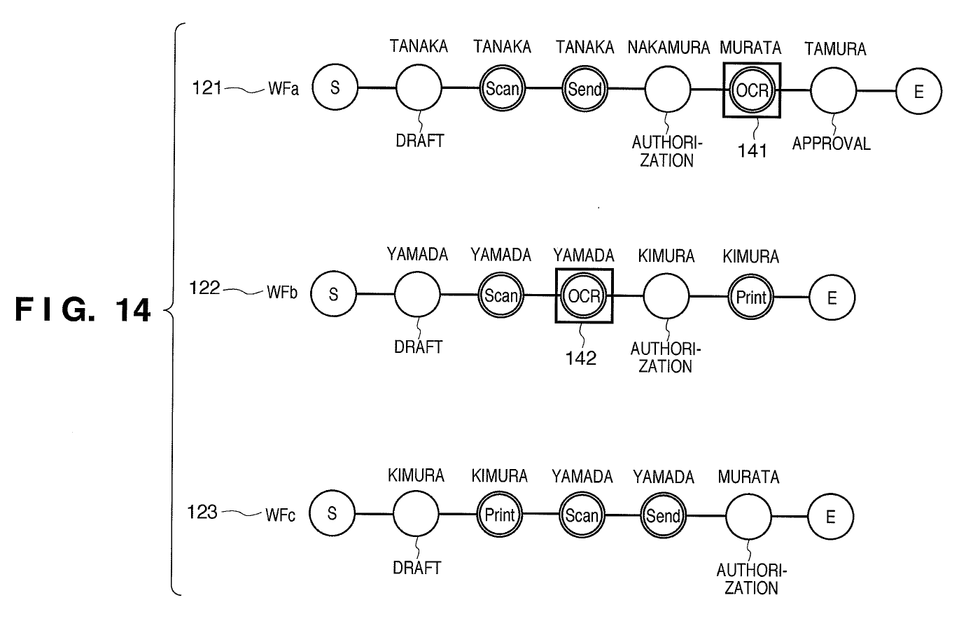

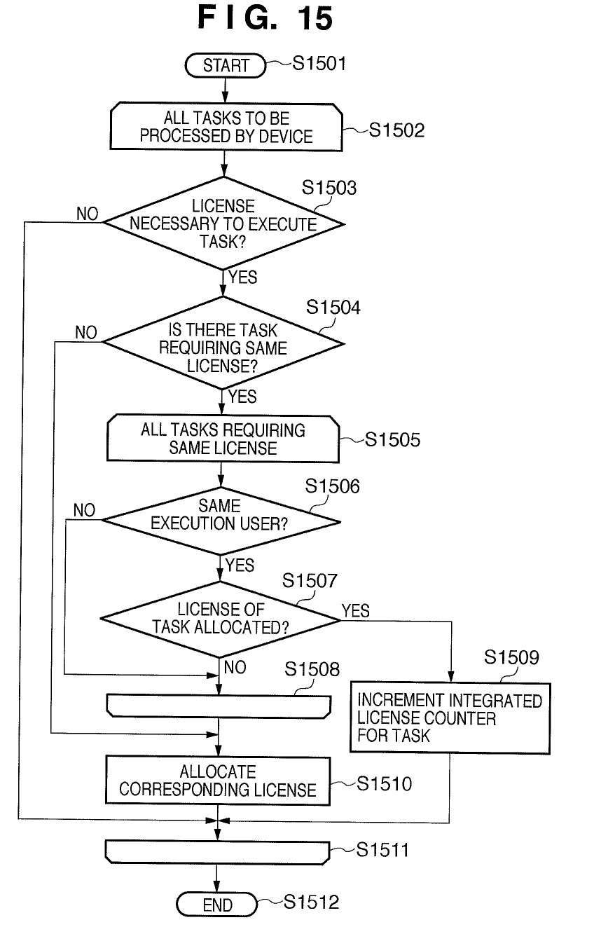

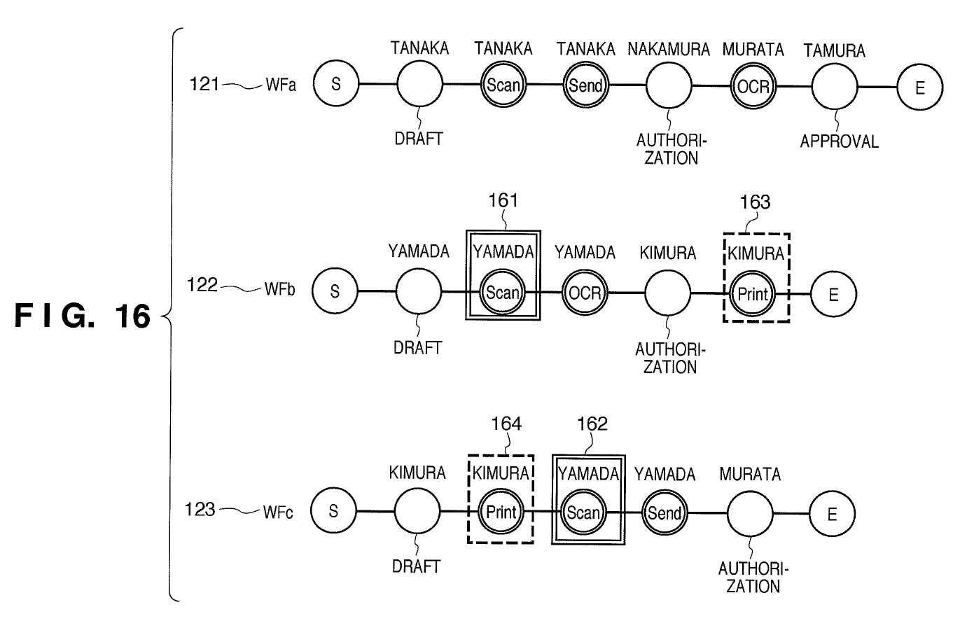

Licenses which are integrated will be called an integrated license. Embodiment 3 will exemplify two license integration methods. One is a method (Embodiment 3-1) of integrating licenses based on the number of task processing devices, which will be explained with reference to FIGS. 13 and 14. The other is a method (Embodiment 3-2) of integrating licenses based on information of a user who processes a task, which will be explained with reference to FIGS. 15 and 16.

<License Allocation Processing Sequence in Embodiment 3-1>

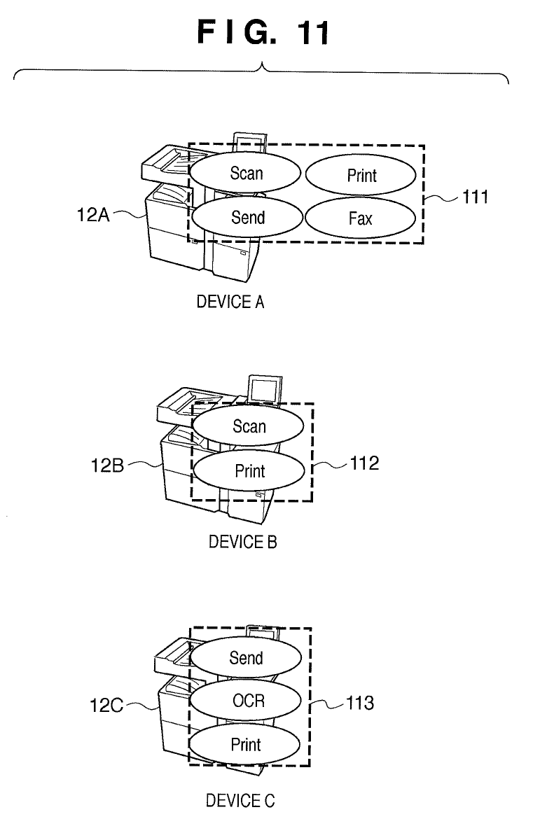

FIG. 11 shows the functions of task processing devices which are applied in Embodiment 3. FIG. 11 shows the functions of a device A 12A, device B 12B, and device C 12C.

The device A 12A has a Scan/Print/Send/Fax function 111.

The device B 12B has a Scan/Print function 112, and the device C 12C has a Send/OCR/Print function 113.

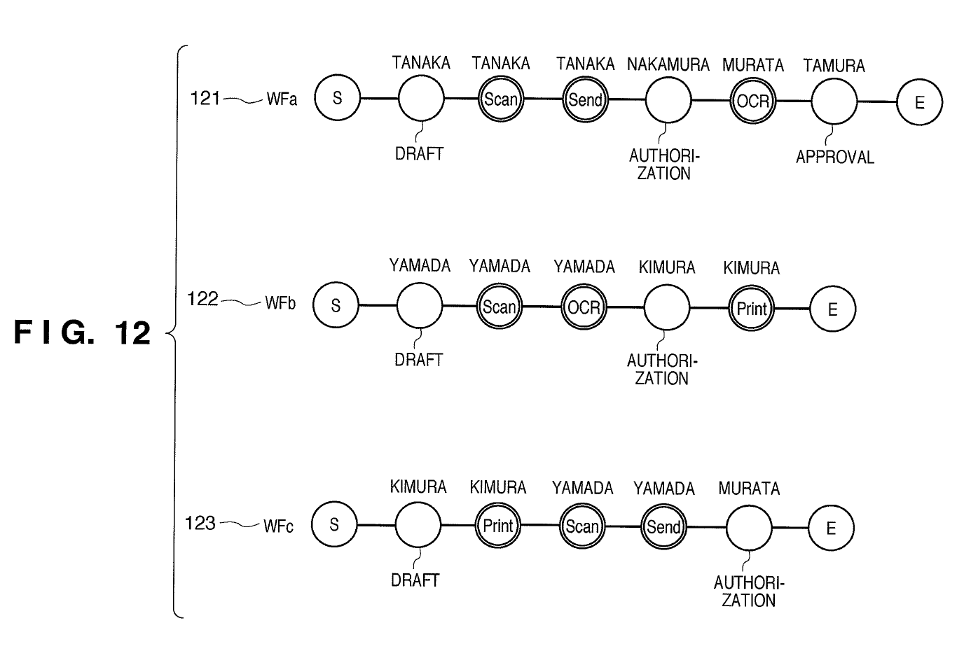

FIG. 12 exemplifies workflows in Embodiment 3. Three workflows, i.e., a workflow a 121, workflow b 122, and workflow c 123 are defined and formed from the following tasks:

the workflow a 121: draft, Scan, Send, authorization, OCR, approval
the workflow b 122: draft, Scan, OCR, authorization, Print
the workflow c 123: draft, Print, Scan, Send, authorization
A user role is assigned to each task.

FIG. 13 shows a license allocation processing sequence by a server 11 in Embodiment 3. This processing is applied to all tasks extracted from a workflow (or a plurality of workflows) in an executable state. It is determined whether a license is necessary to execute a target task extracted from a target workflow (S1303).

If the target task processing does not require a license, the process advances to the next task. If the task processing requires a license, it is determined whether the number of task processing devices capable of executing the target task is one (S1304). If there are a plurality of task processing devices capable of executing the target task, a license for executing the target task is allocated (S1307).

As long as the next task remains, it is set as the target task to repeat the process from S1303. The next task is not limited to a task belonging to one workflow. If an unprocessed workflow remains after processing all tasks belonging to one workflow, a task belonging to the unprocessed workflow is selected as the target task.

If it is determined in S1304 that the number of task processing devices capable of executing the target task is one, it is determined whether a license for executing the target task has already been allocated (S1305).

If the license has already been allocated, an integrated license counter for the target task is incremented, and the process advances to the next task (S1306). If no license has been allocated yet, a license for executing the target task is allocated, and the process advances to the next task (S1307). After processing all tasks, the license allocation processing ends.

When the number of task processing devices capable of executing a function associated with a given task is one in the system, the integrated license counter is associated with a license for the function. The counter represents the number of tasks for which the license is allocated to overlap between them. The initial value is 0, and the counter is incremented by one.

FIG. 14 shows a case in which the license allocation processing is applied to the workflows of FIG. 12 in Embodiment 3. The workflow a 121, workflow b 122, and workflow c 123 are in the start state. As is apparent from the arrangement of the task processing devices in FIG. 11, only the device A 12A has the Fax function and only the device C 12C has the OCR function. Tasks in the respective workflows and the arrangement contents of the task processing devices reveal that only the device C 12C can execute a task 141 (OCR) of the workflow a 121 and a task 142 (OCR) of the workflow b 122. Licenses used for the two tasks are integrated to allocate one license, instead of allocating a plurality of licenses to overlap between the tasks 141 and 142 in order to use the OCR function.

<License Allocation Processing Sequence in Embodiment 3-2>

FIG. 15 shows the second license allocation processing sequence in Embodiment 3. This processing is executed for all tasks extracted from a target workflow, as well as Embodiment 3-1. It is determined whether a license is necessary to execute a target task (S1503).

If no license is necessary to execute a target task, the process advances to the next task. If a license is necessary to execute a target task, it is determined whether there is a task requiring the same license to execute it (S1504). Tasks to be compared are all tasks which are extracted from other workflows and are to be processed by a device. If a task requiring the same license does not exist, a license for executing the target task is allocated, and the process advances to the next task (S1510).

If it is determined in S1504 that there is a task requiring the same license, processes in S1506 and S1507 are executed for all tasks requiring the same license.

It is determined whether the execution user (role) is the same between the target task and the task requiring the same license (S1506).

If the execution user is different, the determination processing advances to the next task requiring the same license. If the execution user is the same, it is determined whether the license for executing the target task has already been allocated (S1507). If no license has been allocated yet, the determination processing advances to the next task requiring the same license. If the license has already been allocated, the integrated license counter for the target task is incremented (S1509).

After that, the process escapes from the loop of S1505 to S1508, and the license allocation processing continues for a task extracted from the next workflow. After applying the processing to all tasks extracted from workflows, the license allocation processing ends.

FIG. 16 shows a case in which the license allocation processing is applied to the workflows of FIG. 12 in Embodiment 3.

The workflow a 121, workflow b 122, and workflow c 123 are in the start state. A user “Yamada” executes a task 161 (Scan) of the workflow b 122 and a task 162 (Scan) of the workflow c 123 among tasks in the workflows, so the licenses of the two tasks are integrated to allocate an integrated license.

Similarly, a user “Kimura” executes a task 163 (Print) of the workflow b 122 and a task 164 (Print) of the workflow c 123, so the licenses of the two tasks are integrated to allocate an integrated license.

<Task Execution Processing Sequence in Embodiment 3>

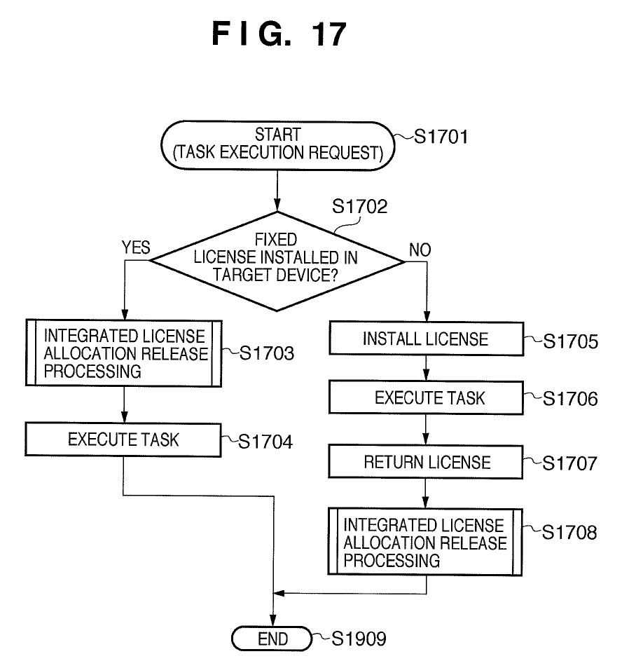

FIG. 17 shows a processing sequence when executing a task in Embodiment 3. This sequence is common to Embodiments 3-1 and 3-2. The process starts when the user requests an arbitrary task processing device to execute a task.

It is determined whether a fixed license capable of executing the task has been installed in the task processing device designated by the user (S1702). If the fixed license has been installed in the task processing device, an integrated license allocated in the server device to execute the task is released (S1703).

The task is then executed (S1704). If no fixed license has been installed, the license allocated in the server device to execute the task is installed in the task processing device (S1705). Then, the task is executed (S1706).

After executing the task, the task processing device returns the license to the server device (S1707). The server device releases the allocated integrated license (S1708), and the process ends.

<Integrated License Allocation Release Processing>

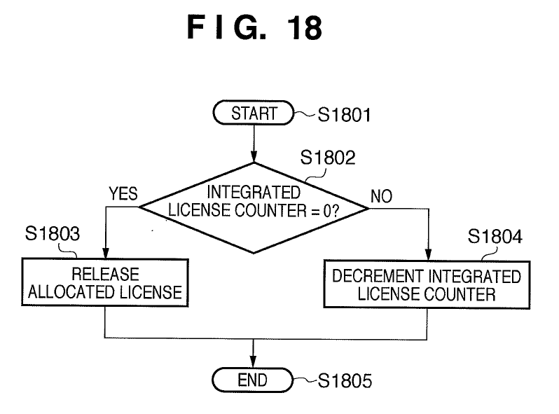

FIG. 18 shows an integrated license allocation release processing sequence in Embodiment 3. When the process starts, it is determined whether the integrated license counter for a target task is 0 (S1802).

If the counter is 0, a license allocated in the server device is released (S1803), and the process ends. If the counter is 1 or more, the integrated license counter is decremented (S1804), and the process ends. At this time, the number of integrated licenses decreases, but the licenses are kept held.

As described above, according to Embodiment 3, when the same user performs processes of the same kind, licenses are integrated to allocate an integrated license. A limited number of licenses can be exploited efficiently.

### Embodiment 4

Embodiment 4 in the present invention will now be described. Embodiment 4 will explain license allocation processing different from those in Embodiments 1, 2, and 3.

Embodiments 1, 2, and 3 have exemplified a case in which licenses necessary to process all tasks extracted from a workflow are allocated at the start of the workflow. However, when a plurality of tasks to be processed by a task processing device include a task to be processed by a user, like an authorization task, the server device needs to keep allocating licenses till the end of the user processing. A limited number of licenses may not be able to be used effectively.

Embodiment 4 will describe an example considering the timing to allocate a license. Embodiment 4 will be explained by exemplifying the workflows shown in FIG. 12.

<License Allocation Processing Sequence in Embodiment 4>

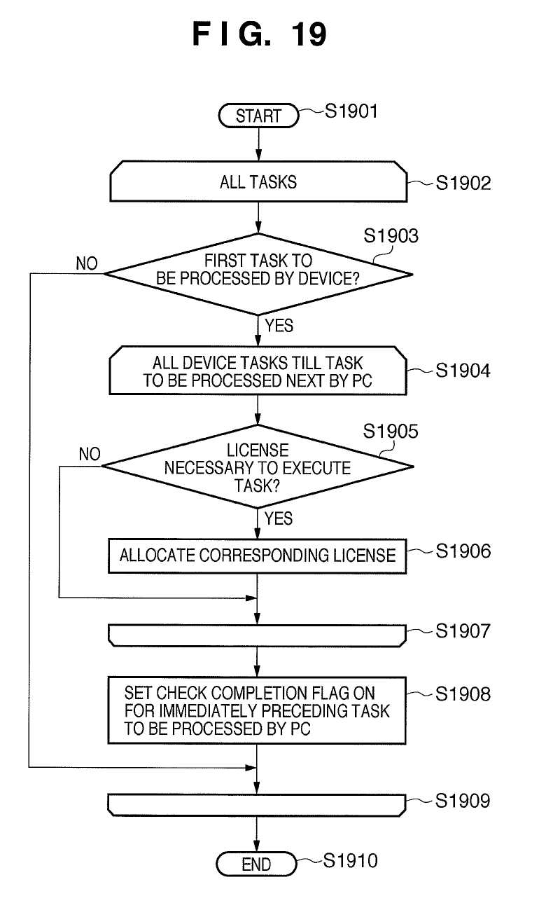

FIG. 19 shows a license allocation processing sequence in Embodiment 4. This processing is executed for all tasks extracted from a workflow. It is determined whether the processing order of a target task by an assigned task processing device is the first (top) in a target workflow (S1903). If the processing order of the target task by the task processing device is not the first, the license allocation processing advances to the next task. If the processing order of the target task is the first, the following processing is executed for all tasks to be processed by the task processing device till a task to be processed next by a computer.

It is determined whether a license is necessary to execute the target task (S1905). If no license is necessary to execute the target task, the processing in S1905 is done for the next task to be executed by the task processing device. If a license is necessary to execute the target task, a license for executing the target task is allocated, and the processing in S1905 is applied to the next task to be executed by the task processing device.

After processing all tasks to be processed by the task processing device till a task to be processed next by a computer, a check completion flag for a task to be processed by a computer (PC) that immediately precedes the task to be processed first by the task processing device is set ON (S1908). This flag is set for each workflow.

The license allocation processing continues for tasks extracted from the next workflow (S1908). After applying the processing to all tasks extracted from the workflow, the processing ends.

<Task Execution Processing Sequence in Embodiment 4>

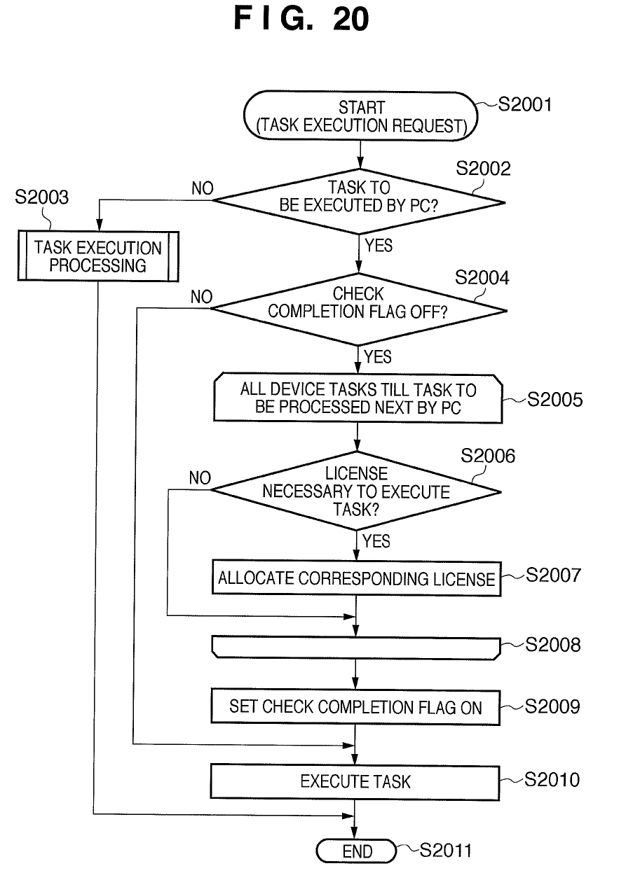

FIG. 20 shows a task execution processing sequence in Embodiment 4. The process starts when the user requests execution of a task. It is determined whether the designated task is one to be executed by a PC (S2002).

If the target task is one to be executed by a task processing device, task execution processing is performed according to the task execution processing sequence shown in FIG. 9 (S2003), and the process ends. If the target task is one to be executed by a PC, it is determined whether a check completion flag for the target task is OFF (S2004). If the check completion flag is ON, the PC executes the target task (S2010), and the process ends. If the check completion flag is OFF, the following processing is executed for all tasks to be processed by the task processing device till a task to be processed next by the PC in the workflow.

It is determined whether a license is necessary to execute the target task (S2006). If no license is necessary, the confirmation processing in S2006 is executed for the next task to be executed by the task processing device. If a license is necessary, a license for executing the target task is allocated, and the confirmation processing is executed for the next task to be executed by the task processing device. Upon completion of the license allocation processing for all tasks to be processed by the task processing device, the check completion flag is set ON (S2009). Thereafter, the PC executes a task (S2010), and the process ends.

### Example in Embodiment 4

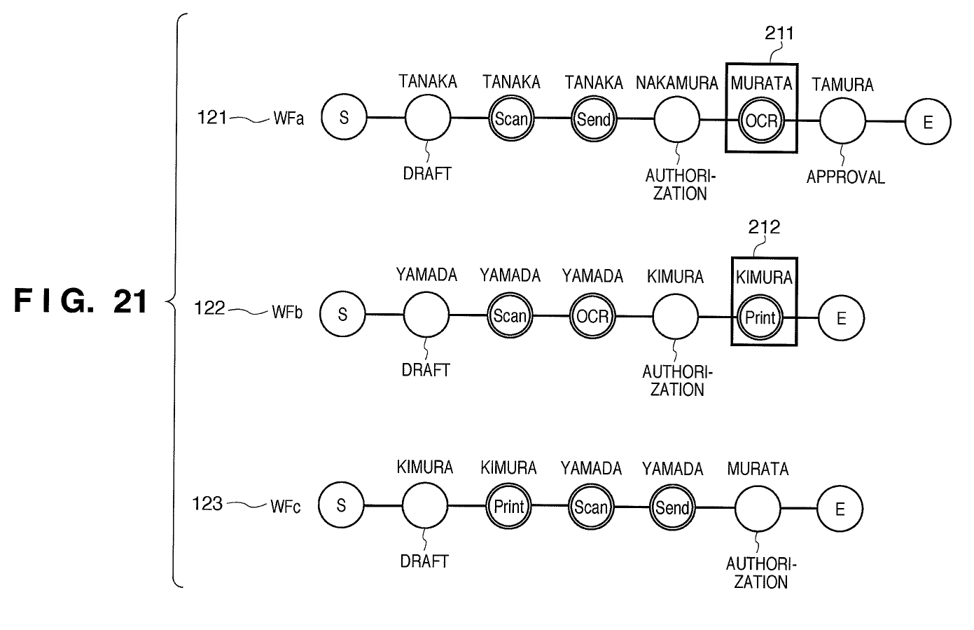

FIG. 21 shows an application of license allocation processing in Embodiment 4 to the workflows of FIG. 12. A license is allocated for a task 211 (OCR) in a workflow a 121 in task execution. Also, a license is allocated for a task 212 (Print) in a workflow b 122 in task execution. Since authorization tasks to be processed by the PC precede the tasks 211 and 212, necessary licenses are allocated upon completion of processing the tasks by the PC.

In Embodiment 4, the license allocation condition is that the target task requires a license. However, a license may be allocated in consideration of the license state of a task processing device, as described in Embodiment 1.

As described above, according to Embodiment 4, a limited number of licenses can be used efficiently by optimizing the license allocation timing in accordance with the processing order of tasks in a workflow.

### Embodiment 5

Embodiment 5 in the present invention will now be described. Embodiment 5 will explain license allocation processing different from those in Embodiments 1, 2, 3, and 4.

Embodiments 1 to 4 have exemplified a case in which when a license is necessary to process a task in a workflow, the server device allocates it. Embodiment 5 will exemplify a case in which when one task processing device can be identified to execute a target task, a license is installed in the task processing device, instead of allocating a license.

<License Allocation Processing Sequence in Embodiment 5>

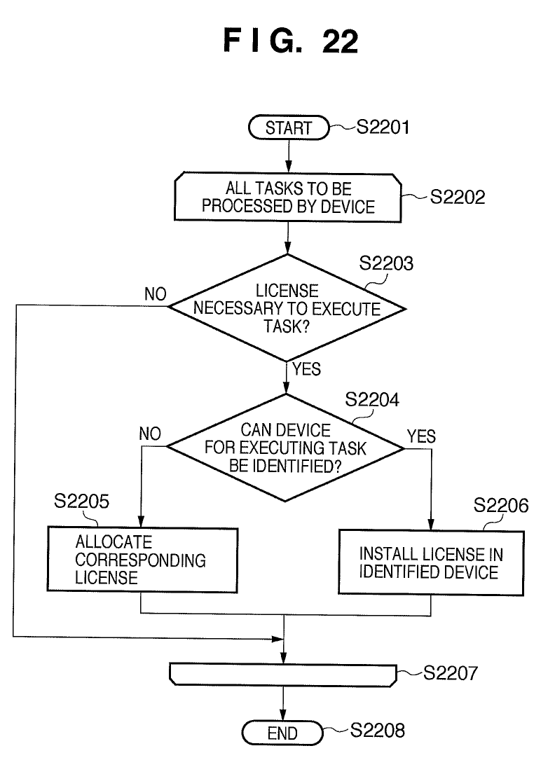

FIG. 22 shows a license allocation processing sequence in Embodiment 5. This processing is executed for all tasks which are extracted from a target workflow and are to be processed by a task processing device.

It is determined whether a license is necessary to execute a task extracted from a workflow (S2203). If the task does not require a license, the processing is applied to the next task. If the task requires a license, it is determined whether one task processing device can be identified to execute the target task (S2204).

If one task processing device cannot be identified to execute the target task and a plurality of task processing devices exist, a license for executing the target task is allocated (S2205). If one task processing device can be identified to execute the target task, a license for executing the target task is installed in the identified task processing device (S2206).

Then, the processing is applied to the next task. After applying the processing to all tasks, the license allocation processing ends.

Conditions to identify one task processing device for executing a task are as follows:

Only a target task processing device has a function capable of executing a task.

Only the function of a target task processing device is usable owing to a trouble or the like.

A user who is to execute a task can use only a target task processing device owing to access right or the like.

However, the conditions are not limited to them.

In Embodiment 5, the license allocation condition is that the target task requires a license. However, a license may be allocated in consideration of the license state of a task processing device, as described in Embodiment 1.

As described above, according to Embodiment 5, when one task processing device can be identified to process a task, a necessary license is installed in advance, reducing the overhead in task execution.

The embodiments of the present invention have been described above. Processes described in these embodiments can be freely combined and implemented.

For example, Embodiments 3 and 5 can be combined. In this case, different processes are performed between a case in which a task processing device can be identified and a case in which it cannot be identified. Efficient processing can be achieved in conformity to the arrangement of a cooperative task processing system.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-000389, filed Jan. 5, 2009, which is hereby incorporated by reference herein in its entirety.

What is claimed is:

1. A workflow management device which executes, by using a task processing device, a series of processes for document data as a workflow formed from a combination of tasks, the workflow management device comprising:
a determination unit which determines,
sequentially for the tasks in the workflow, whether to execute a target task by the task processing device;
a license allocation unit which, when the determination unit determines to execute the target task by the task processing device, allocates a license necessary to execute the target task by the task processing device;
a license determination unit which determines whether a license is necessary when executing the target task;
an installation unit which, when a license is determined to be necessary, installs the license allocated by the license allocation unit in a target task processing device for processing the target task; and
a license allocation release unit which, when a license is determined to be unnecessary, releases the license allocated by the license allocation unit.

2. The device according to claim 1, wherein the license allocation unit allocates, in accordance with processing and a device status, a license for executing the target task.

3. The device according to claim 1, wherein the license allocation unit identifies all task processing devices capable of executing the target task, and when the identified all task processing devices capable of executing the target task include a task processing device having no license for the target task, allocates a license for the task processing device.

4. The device according to claim 1, wherein when one task processing device capable of executing the target task can be identified and a license of the target task has already been allocated for another workflow, the license allocation unit allocates the license to overlap between a plurality of workflows.

5. The device according to claim 1, wherein when another task which requires the same license as a license of the target task and belongs to another workflow exists, an execution user is the same between the other task and the target task, and the license of the target task has already been allocated for another workflow, the license allocation unit allocates the license to overlap between a plurality of workflows.

6. The device according to claim 4, wherein the license allocation release unit determines whether the license of the target task is allocated to overlap between a plurality of workflows, when the license of the target task is allocated to overlap between a plurality of workflows, keeps allocating the license, and when the license is not allocated to overlap between a plurality of workflows, releases the license.

7. The device according to claim 1, wherein when the workflow contains a task to be processed by a client computer in addition to a task by the task processing device, the license allocation unit allocates licenses of tasks to be processed by the task processing device between a first task to be processed by the task processing device and a first task to be processed by the client computer.

8. The device according to claim 1, wherein when one task processing device capable of processing the target task can be identified, the installation unit installs a license of the target task in the identified task processing device.

9. A cooperative task processing system comprising:
a workflow management device defined in claim 1; and
a task processing device which is connected to the workflow management device and executes a task assigned by the workflow management device when the task processing device has a license of the task.

10. A workflow management method in a workflow management device for executing, by using a task processing device, a series of processes for document data as a workflow formed from a combination of tasks, the method comprising:
a determination step of causing a determination unit of the workflow management device to determine, sequentially for the tasks in the workflow, whether to execute a target task by the task processing device;
a license allocation step of causing a license allocation unit of the workflow management device to, when the target task is determined in the determination step to be executed by the task processing device, allocate a license necessary to execute the target task by the task processing device;
a license determination step of causing a license determination unit of the workflow management device to determine whether a license is necessary when executing the target task;
an installation step of causing an installation unit of the workflow management device to, when a license is determined to be necessary, install the license allocated in the license allocation step in a target task processing device for processing the target task; and
a license allocation release step of causing a license allocation release unit of the workflow management device to, when a license is determined to be unnecessary, release the license allocated in the license allocation step.

11. A program for causing a computer to function as each unit of a workflow management device defined in claim 1.
